(19) United States
(12) Patent Application Publication
(10) Pub. No.: US 2023/0107133 A1
(43) Pub. Date: Apr. 6, 2023

(54) SYSTEM AND METHOD FOR CLOUD-SERVICE PROVIDER AGNOSTIC USAGE TRACING AND METERING BASED ON SERVICE INSTANCE

(71) Applicant: Dell Products L.P., Round Rock, TX (US)

(72) Inventors: Rizwan Ali, Cedar Park, TX (US); Ravikanth Chaganti, Bangalore (IN); Dharmesh M. Patel, Round Rock, TX (US)

(21) Appl. No.: 17/492,258

(22) Filed: Oct. 1, 2021

(51) Int. Cl. G06F 9/455; G06F 9/50

(52) U.S. Cl. CPC G06F 9/45558; G06F 9/5077; G06F 2009/45595; G06F 2009/45579; G06F 2009/45591

(57) ABSTRACT

A method for managing a cloud service provider (CSP) includes detecting, by a service instance monitoring agent, usage of an infrastructure direct tracing (IDT) component, wherein the CSP comprises the IDT component, based on the usage, identifying a service instance associated with the usage of the IDT component, identifying a hardware resource corresponding to the IDT component, updating a resource usage data structure that specifies the IDT component, the usage, and the hardware resource, and providing a resource usage report to a client associated with the IDT component.

### BACKGROUND

Computing devices in a system may include any number of internal components such as processors, memory, and persistent storage. As computing devices experience failures, internal or external systems may track undesirable behaviors by applications executed using the internal components.

### SUMMARY

In general, in one aspect, the invention relates to a method for managing a cloud service provider (CSP). The method includes detecting, by a service instance monitoring agent, usage of an infrastructure direct tracing (IDT) component, wherein the CSP comprises the IDT component, based on the usage, identifying a service instance associated with the usage of the IDT component, identifying a hardware resource corresponding to the IDT component, updating a resource usage data structure that specifies the IDT component, the usage, and the hardware resource, and providing a resource usage report to a client associated with the IDT component.

In general, in one aspect, the invention relates to a non-transitory computer readable medium that includes instructions computer readable program code, which when executed by a computer processor enables the computer processor to perform a method for managing a cloud service provider (CSP). The method includes detecting, by a service instance monitoring agent, usage of an infrastructure direct tracing (IDT) component, wherein the CSP comprises the IDT component, based on the usage, identifying a service instance associated with the usage of the IDT component, identifying a hardware resource corresponding to the IDT component, updating a resource usage data structure that specifies the IDT component, the usage, and the hardware resource, and providing a resource usage report to a client associated with the IDT component

In general, in one aspect, the invention relates to a system that includes a system that includes a processor and memory that includes instructions, which when executed by the processor, perform a method. managing a cloud service provider (CSP). The method includes detecting, by a service instance monitoring agent, usage of an infrastructure direct tracing (IDT) component, wherein the CSP comprises the IDT component, based on the usage, identifying a service instance associated with the usage of the IDT component, identifying a hardware resource corresponding to the IDT component, updating a resource usage data structure that specifies the IDT component, the usage, and the hardware resource, and providing a resource usage report to a client associated with the IDT component

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of an infrastructure direct tracing (IDT) component in accordance with one or more embodiments of the invention.

FIG. 2A shows a flowchart of a method of generating resource usage information for a service instance utilizing an IDT component in accordance with one or more embodiments of the invention.

FIG. 2B shows a flowchart of a method of generating resource usage information for a service instance utilizing an IIT component in accordance with one or more embodiments of the invention.

FIG. 2C shows a flowchart of a method of providing resource usage reports in accordance with one or more embodiments of the invention.

FIG. 3 show an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for managing the tracing of usage of resources in a cloud service provider (CSP). Embodiments of the invention provide methods for the cloud service provider to trace the usage of resources (e.g., hardware resources, logical resources, etc.) of the CSP to be used to generate resource usage reports for the purpose of providing such resource usage reports to a client. The resource usage report may provide transparency to the client when obtaining invoices that specify the financial cost for using the CSP. In an initial contract between a user of the client and the CSP, the user may agree to pay based on the usage of the CSP. A CSP providing the invoice may specify the cost of use for the CSP. Further, the resource usage report may specify usage details of the service instances used by the client, and the resources used by the service instances in response to servicing the client.

The usage details may be obtained by service instance monitoring agents that perform direct or indirect tracing of resources. Direct tracing may be performed on service instances operating on infrastructure direct tracing (IDT) components. The IDT components may execute the service instance monitoring agents. The service instance monitoring agents, after detecting usage of a service instance, may identify the hardware resources used by the service instance, and update hardware resource usage information to specify the service instance, the usage, and the resources that were used.

In one or more embodiments of the invention, the CSP includes components that are not traced directly. Such components (also referred to as infrastructure indirect tracing (IIT) components) may be traced by the service instance monitoring agents operating external to the IIT components. The IIT components may be indirectly traced by sending requests to the IIT components to provide usage information regarding the service instances utilizing the IIT components. The service instance monitoring agent may update the resource usage information based on the responses to the requests obtained from the IIT devices.

In one or more embodiments of the invention, the CSP further includes a service instance aggregate usage manager that aggregates resource usage information for the service instances to generate the resource usage reports. The resource usage information may specify, for example, whether the service instance migrates from one IDT component to another, and, if so, may specify aggregate resource usage information from the multiple IDT components. In this manner, the resource usage report comprehensively specifies the resource usage of the service instance throughout the CSP. The resource usage report may be provided to the client corresponding to the service instance. The resource usage report may be provided, for example, following an invoice sent to the user.

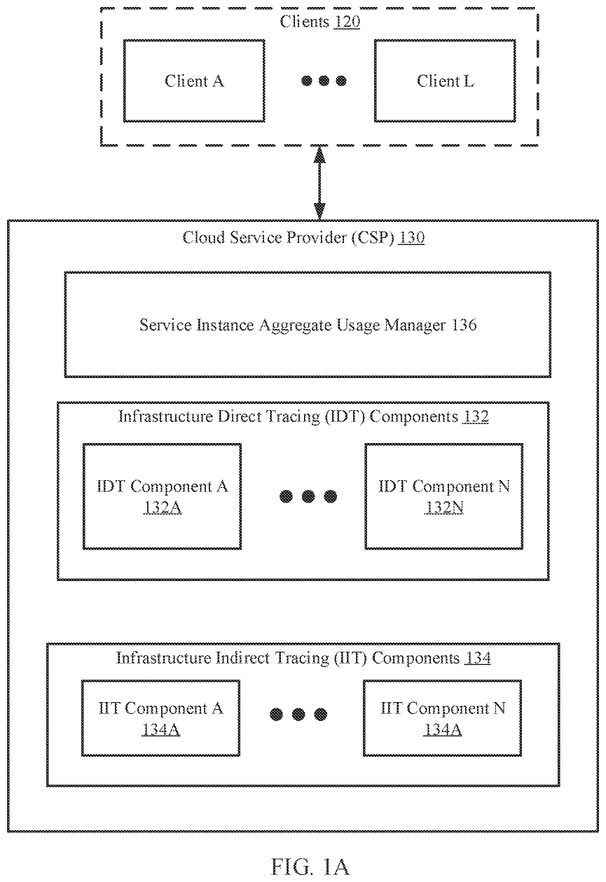

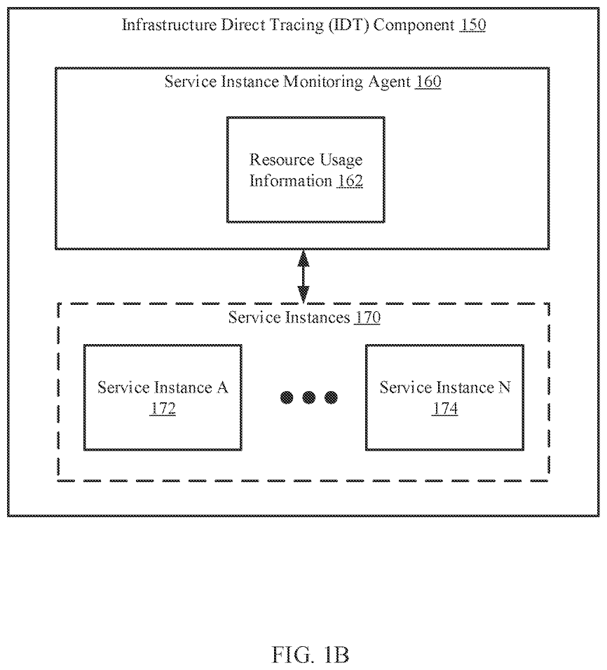

FIG. 1A shows a diagram of a system in accordance with one or more embodiments of the invention. The system includes one or more clients (120), a CSP (130), a service instance aggregate usage manager (136), one or more IDT components (132), and one or more IIT components. The system may include additional, fewer, and/or different components without departing from the invention.

In one or more embodiments of the invention, the clients (120) are associated with users that utilize the services of the CSP (130). Each user may participate in a subscription to the CSP (130) where the user agrees to pay based on the usage of the resources of the CSP (130). The CSP may provide invoices, or other forms of specifying the payment, to the clients (120) to be accessed by the users. For example, the subscription may specify the cost of usage of the resources of the CSP (130).

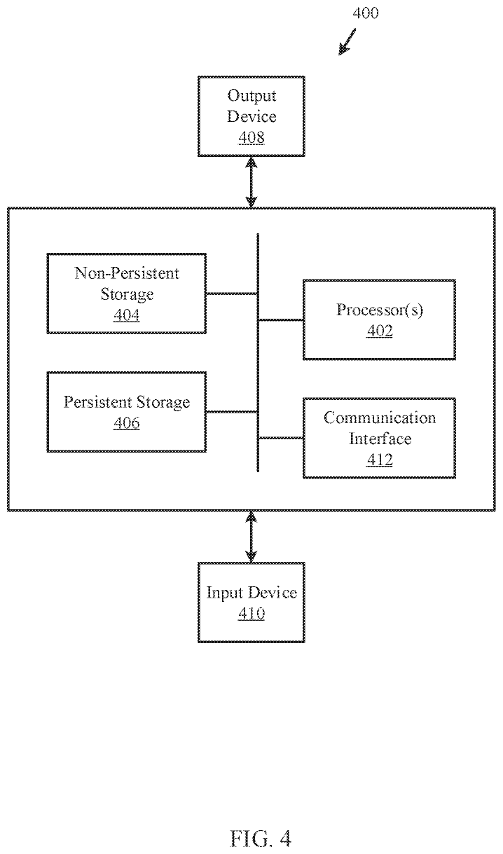

In one or more embodiments of the invention, each client (120A, 120L) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of each client (120A, 120L) described throughout this application.

In one or more embodiments of the invention, each client (120A, 120L) is implemented as a logical device. The logical device may utilize the computing resources of any number of computing devices and thereby provide the functionality of the client (120A, 120L) described throughout this application.

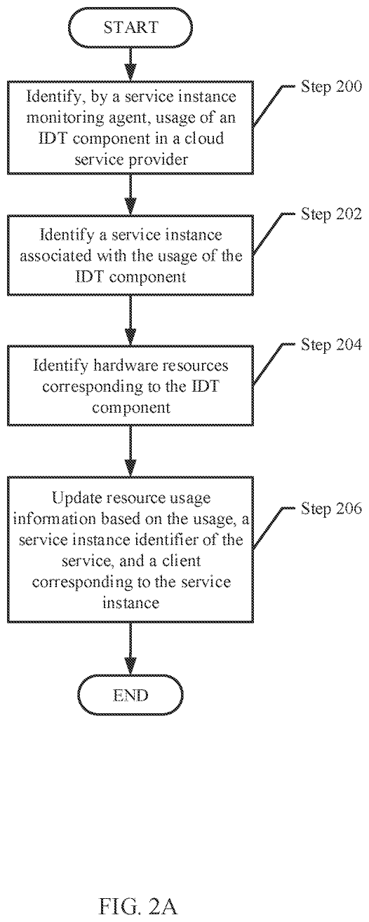

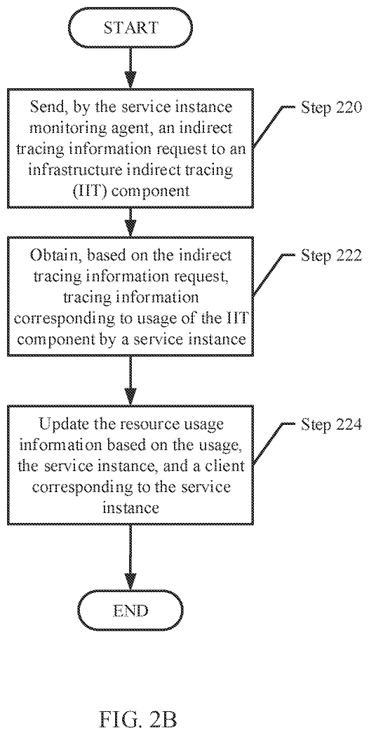

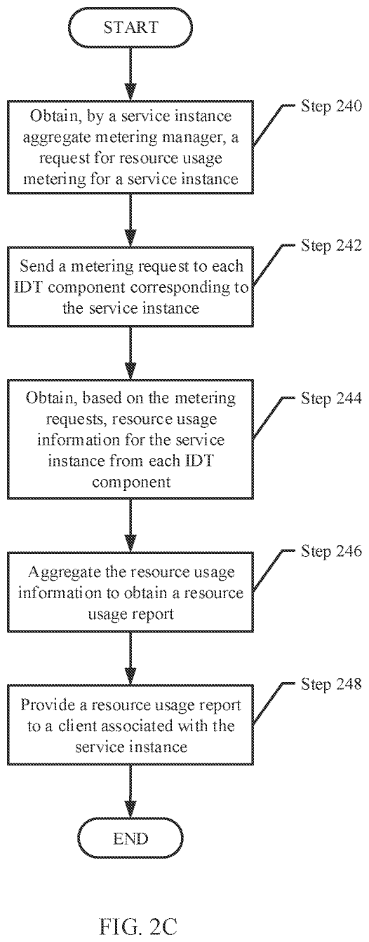

In one or more embodiments of the invention, the service instance aggregate usage manager (136) manages the communication of resource usage information between the CSP (130) and the clients (120). The service instance aggregate usage manager (136) may manage the communication by obtaining the resource usage information from the IDT components (134), identifying the service instance(s) associated with the resource usage information, aggregating the resource usage information based on the identified service instances, and providing resource usage reports that specifies the resource usage information to the clients (120). The resource usage reports may be prepared and generated to specify the services instances, the resource usage of the service instances, and any terms agreed to by the clients associated with the service instances regarding any financial transactions to be executed based on the resource usage. For example, resource usage report may be generated and provided to the client in response to an invoice provided to the clients (120). The invoice may specify the financial payments to be provided by an entity managing the clients (120) in response to an agreement to use the services of the CSP. The resource usage reports may be generated in accordance with FIG. 2C.

In one or more embodiments of the invention, the service instance aggregate usage manager (136) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the service instance aggregate usage manager (136) described throughout this application and/or the method illustrated in FIG. 2C.

In one or more embodiments of the invention, the service instance aggregate usage manager (136) is implemented as a logical device. The logical device may utilize the computing resources of any number of computing devices and thereby provide the functionality of the service instance aggregate usage manager (136) described throughout this application.

In one or more of embodiments of the invention, the service instance aggregate usage manager (136) is implemented as computer instructions, e.g., computer code, stored on a persistent storage that when executed by a processor(s) of the CSP (130) cause the CSP (130) to provide the functionality of the service instance aggregate usage manager (136) described throughout this application.

In one or more embodiments of the invention, the IDT components (132) and IIT components (134) provide services to the clients (120). The services may include executing services instances (discussed below in FIG. 1B) that execute for the clients. The service instances may utilize the resources of the CSP (130). For additional details regarding the IDT components, see, e.g., FIG. 1B.

As used herein, direct tracing may refer to the process of detecting the usage of resources by a service instance in an IDT component (132A, 132N) and the processing of such detection in accordance with FIG. 2A. While the service instance may execute in an IDT component (132A, 132N) (as is discussed in FIG. 1B), the service instance may further utilize the resources of the IIT components (134). As such, indirect tracing may refer to the process of detecting the usage of resources in an IIT component (134A, 134N) by a service instance. For clarity, the process of performing such indirect tracing may be processed in accordance with the method of FIG. 2B.

In one or more embodiments of the invention, the IIT components (134) may be implemented as hardware resources such as, for example, storage devices. The IIT components (134) may be differentiated from the IDT components (132) based on the fact that IIT components do not execute service instances, yet provide resources for use by the service instances.

To aid in providing services by a CSP, the CSP in accordance with embodiments of the invention may include a IDT component. Turning to FIG. 1B, FIG. 1B shows a diagram of an IDT component (150) in accordance with one or more embodiments of the invention. The IDT component (150) illustrated in FIG. 1B may be similar to an IDT component (132A, 132N) of FIG. 1.

As discussed above, the IDT component (150) may provide services to clients. The IDT component (150) includes a service instance monitoring agent (160) and any number of service instances (170). The IDT component (150) may include additional, fewer, and/or different components without departing from the invention. Each of the components of the IDT component (150) illustrated in FIG. 1B is discussed below.

In one or more embodiments of the invention, the service instance monitoring agent (160) gathers resource usage information (162) that specifies information regarding the usage of resources by the service instances (170). The resource usage may be measured based on usage of resources of the IDT component (150) and/or usage of resources of IIT components (e.g., 134, FIG. 1A) discussed above. The service instance monitoring agent (160) may generate the resource usage information (162) in accordance with FIGS. 2A and 2B.

In one or more embodiments of the invention, the resource usage information (162) is a data structure that specifies the usage of resources (e.g., hardware, software, etc.) of the CSP. The resources may be provided by the IDT component (150), by any number of IIT components (discussed above), and/or any other components of the CSP without departing from the invention. The resource hardware usage information (162) may include, for example, entries that specify the service instance, the corresponding user, and the usage of resources. The usage of the resources may be specified in a format associated with the corresponding usage. For example, the usage of a storage device may be specified in total amount of data used, the usage of a network line card to transfer data between components in the CSP may be specified in total bandwidth used, etc.

In one or more of embodiments of the invention, the service instance monitoring agent (160) is implemented as computer instructions, e.g., computer code, stored on a persistent storage that when executed by a processor(s) of the IDT component (150) cause the IDT component (150) to provide the functionality of the service instance monitoring agent (160) described throughout this application and/or the methods of FIG. 2A-2B.

In one or more embodiments of the invention, the service instances (170) utilize the resources of the IDT component (150) and/or any IIT component discussed above to provide services to the users. Each of the service instances (172, 174) may be performing similar or different processes. In one or more embodiments of the invention, the service instances (170) provide services to users, e.g., clients. For example, the service instances (170) may be, for example, instances of databases, email servers, and/or other components. The service instances (170) may be instances of other services without departing from the invention.

In one or more of embodiments of the invention, the service instances (172, 174) are implemented as computer instructions, e.g., computer code, stored on a persistent storage that when executed by a processor(s) of the IDT component (150) cause the IDT component (150) to provide the functionality of the applications (132) described throughout this application.

In one or more embodiments of the invention, the IDT component (150) is implemented using computing devices. The computing devices may be, for example, mobile phones, tablet computers, laptop computers, desktop computers, servers, distributed computing systems, embedded computing devices, or a cloud resource. The computing devices may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to provide the functionality of the IDT component (150) described through this application and all, or a portion, of the methods illustrated in FIGS. 2A-2B. The IDT component (150) may be implemented using other types of computing devices without departing from the invention. For additional details regarding computing devices, refer to FIG. 4.

In one or more embodiments of the invention, the IDT component (150) is implemented using distributed computing devices. As used herein, a distributed computing device refers to functionality provided by a logical device that utilizes the computing resources of one or more separate and/or distinct computing devices. For example, in one or more embodiments of the invention, the IDT component (150) is implemented using distributed devices that include components distributed across any number of separate and/or distinct computing devices. In such a scenario, the functionality of the IDT component (150) may be performed by multiple, different computing devices without departing from the invention.

In one or more embodiments of the invention, the IDT component (150) is implemented using a hardware device including circuitry. The IDT component (150) may be implemented using, for example, a digital signal processor, a field programmable gate array, or an application specific integrated circuit. The IDT component (150) may be implemented using other types of hardware devices without departing from the invention.

In one or more embodiments of the invention, the IDT component (150) is implemented using computing code stored on a persistent storage that when executed by a processor performs all, or a portion, of the functionality of the IDT component (150). The processor may be a hardware processor including circuitry such as, for example, a central processing unit or a microcontroller. The processor may be other types of hardware devices for processing digital information without departing from the invention.

While the IDT component (150) of FIG. 1B has been described and illustrated as including a limited number of specific components for the sake of brevity, an environmental manager in accordance with embodiments of the invention may include additional, fewer, and/or different components than those illustrated in FIG. 1B without departing from the invention.

FIGS. 2A-2C show flowcharts in accordance with one or more embodiments of the invention. While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIGS. 2A-2C may be performed in parallel with any other steps shown in FIGS. 2A-2C without departing from the scope of the invention.

FIG. 2A shows a flowchart of a method of generating resource usage information for a service instance utilizing an IDT component in accordance with one or more embodiments of the invention. The method shown in FIG. 2A may be performed by, for example, a service instance monitoring agent (160, FIG. 1B). Other components of the system illustrated in FIG. 1 may perform the method of FIG. 2A without departing from the invention.

Turning to FIG. 2A, in step 200, usage of an IDT component in a CSP is identified. In one or more embodiments of the invention, the usage is identifying by monitoring the resources of the IDT component by the service instance monitoring agent and detecting usage of the resources during the monitoring. The usage may include, for example, executing processes using a processor of the IDT component that result in performing a service for a user. The service may be provided by a service instance. As another example, the usage may include sending data across multiple IDT components using a network line card of the IDT component. As another example, the usage includes executing software initiated by a service instance to service requests obtained from a client.

In step 202, a service instance associated with the usage of the IDT component is identified. In one or more embodiments of the invention, the service instance is identified by tracing the usage to determine the service instance initiating the usage. For example, if the usage is transferring data, the service instance monitoring agent may obtain metadata associated with the data to identify the service instance initiating the data transfer. As another example, the service instance is identified by initiating an application programming interface (API) command that specifies obtaining the activity performed by the service instance. The API command may result in obtaining a data structure that specifies the usage.

In step 204, resources corresponding to the IDT component are identified. In one or more embodiments of the invention, the resources may be hardware resources. For example, the resources may be the processors used to execute services by the service instances, network line cards used to transfer data, memory pools used to allocate memory to be used by the service instance, and/or storage devices allocating physical storage addresses to store data for the service instance.

In one or more embodiments of the invention, the resources are applications and/or software-implemented resources. For example, the resources may be logical memory addresses that are mapped to physical memory. As a second example, the resources are operating systems of an IDT component.

In step 206, resource usage information is updated. In one or more embodiments of the invention, the resource usage information is updated based on the usage of the resources. The resource usage information may specify the service instance, each resource, its corresponding usage by the service instance, (e.g., an amount of usage for each resource), and the timestamps for the usage. The service instance may be specified using a service instance identifier.

FIG. 2B shows a flowchart of a method of generating resource usage information for a service instance utilizing an IIT component in accordance with one or more embodiments of the invention. The method shown in FIG. 2B may be performed by, for example, a service instance monitoring agent (e.g., 160, FIG. 1B). Other components of the system illustrated in FIG. 1 may perform the method of FIG. 2B without departing from the invention.

In step 220, an indirect tracing information request is sent to an IIT component. In one or more embodiments of the invention, the indirect tracing information request is sent to the IIT component by the service instance monitoring agent. Alternatively, the indirect tracing information request is sent to the IIT component by the service instance utilizing the IIT component in response to a request obtained by the service instance from the service instance monitoring agent. As another alternative, the indirect tracing information request is sent to the IIT component using an API command for an API executing on the IIT component. The API command may specify the service instance (e.g., using a service instance identifier) and the usage of resources by the specified service instance.

In step 222, tracing information is obtained corresponding to usage of the IIT component by a service instance. In one or more embodiments of the invention, the tracing information specifies the service instance, the resources of the IIT component (e.g., the physical addresses of a storage device implemented as the IIT component used for storing data by the service instance) used by the service instance, and timestamps of the usage.

In step 224, the resource usage information is updated. In one or more embodiments of the invention, the resource usage information is updated based on the usage of the resources. The resource usage information may specify the service instance, each resource, its corresponding usage by the service instance, (e.g., an amount of usage for each resource), and the timestamps for the usage. The service instance may be specified using a service instance identifier.

FIG. 2C shows a flowchart of a method of providing resource usage reports in accordance with one or more embodiments of the invention. The method shown in FIG. 2C may be performed by, for example, a service instance usage manager (e.g., 136, FIG. 1A). Other components of the system illustrated in FIG. 1A may perform the method of FIG. 2C without departing from the invention.

In step 240, a request for resource usage metering for a service instance is obtained. In one or more embodiments of the invention, the request is obtained from a client. The request may specify obtaining the resource usage information of a service instance operating to service the client. The request may be sent in response to obtaining, by the client, an invoice that specifies the financial charges applied to the user for the usage of the CSP. The user may desire to know how the financial charges relate to the usage. The request may specify that desire.

In step 242, a metering request is sent to each IDT component corresponding to the service instance. In one or more embodiments of the invention, the metering request is sent to each IDT component that hosted the service instance. For example, the service instance may migrate between IDT components. In this example, the first IDT component hosting the service instance may include resource usage information, and a second IDT component to which the service instance migrates may include second resource usage information. The metering requests may be sent to both IDT components to obtain the resource usage information of both IDT components.

In step 244, resource usage information is obtained for the service instance from each IDT component. The resource usage information may be obtained in response to the metering requests. The resource usage information may specify the service instance and the usage of the resources by the service instance.

In step 246, the resource usage information is aggregated to obtain a resource usage report. In one or more embodiments of the invention, the resource usage information is a data structure that aggregates the resource usage information of the IDT components in a format readable to the user.

In step 248, the resource usage report is provided to a client associated with the service instance. In one or more embodiments of the invention, the resource usage report is sent via a network connection between the CSP and the client.

### Example

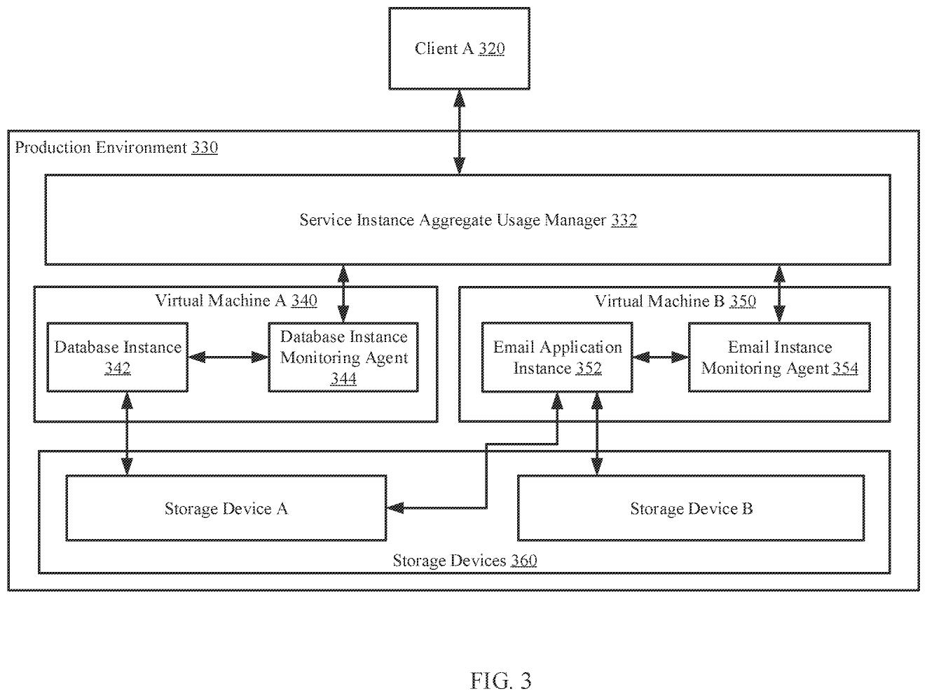

The following section describes an example. The example, illustrated in FIG. 3, is not intended to limit the invention and is independent from any other examples discussed in this application. Turning to the example, consider a scenario in which a client utilizes services provided by a cloud service provider (CSP).

FIG. 3 shows an example system in accordance with one or more embodiments of the invention. For the sake of brevity, not all components of the example system may be illustrated. The example system includes a client (320) and a CSP (330).

The client (320) may utilize the services of two virtual machines (virtual machine A (340) and virtual machine B (350)). The client (320) may utilize both virtual machines (340, 350) based on a subscription by the client (320) to the CSP (330). The virtual machines (340, 350) may be IDT components. Virtual machine A (340) may provides database instance (342) that stores data for a database. Virtual machine A (340) further includes a database instance monitoring agent (344) that monitors the activity of the database instance (342). The usage of the database instance (342) is traced by the database instance monitoring agent (344). The data generated by the database instance (342) may be stored in storage device A (362).

Virtual machine B (350) provides an email application instance (342) that generates and provides data corresponding to emails of a user of the client (320). Virtual machine B (350) further includes an email instance monitoring agent (354) that monitors the activity of the email application instance (352). The usage of the email application instance (352) is traced by the email instance monitoring agent (354). The data generated by the email application instance (352) is stored in storage devices A (362) and B (364).

The database instance monitoring agent (344) performs direct tracing of the resource usage of the database instance (342) in accordance with FIG. 2A to generate resource usage information corresponding to the usage of resources of virtual machine A (340) by the database instance (342). Further, the database instance monitoring agent (344) performs indirect tracing of the usage of storage device A (362) by the database instance (342) in accordance with FIG. 2B. The indirect tracing includes sending indirect tracing information requests to the database instance (342) that specifies obtaining the data stored in the storage device (362) by the database instance (342). The database instance (342) may provide the requested information. The requested information may be used to update the resource usage information.

The email instance monitoring agent (354) performs direct tracing of the resource usage of the email application instance (352) in accordance with FIG. 2A to generate second resource usage information corresponding to the usage of resources of virtual machine B (350) by the database instance (352). Further, the email instance monitoring agent (354) performs indirect tracing of the usage of storage devices A and B (362, 364) by the email application instance (352) in accordance with FIG. 2B. The indirect tracing includes sending indirect tracing information requests to the email application instance (352) that specifies obtaining the data stored in the storage devices (362, 364) by the email application instance (352). The database instance (342) may provide the requested information. The requested information may be used to update the second resource usage information.

At a later point in time, the client (320) may obtain an invoice by an entity (not shown) managing the financial transactions between the user operating the client (320) and the owner of the CSP (330). In response to the invoice, the user may desire to obtain a detailed report that specifies the usage of the CSP resources to explain the financial charges. The client may send a request for a resource usage report to a service instance aggregate usage manager (332). The service instance aggregate usage manager (332) sends metering request to each virtual machine (340, 350) to obtain resource usage information from each virtual machine (340, 350) that corresponds to the services instances (342, 352) servicing the client (320). Using the obtained resource usage information, the service instance aggregate usage manager (332) generates the resource usage report that specifies the resource usage of the virtual machines (340, 350) and the storage devices (360) by the database instance (342) and the email application instance (352).

End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the transparency between owners of a cloud service provider and the users utilizing its resources. Embodiments of the invention provide a method for granular tracing of activity by service instances operating for the service of the users. The activity may be tracked and aggregated in a resource usage report that is provided to clients operated by the users to provide the users with the information that relates any financial charges by the owner of the CSP to the user based on the usage of the CSP. In this manner, the user is made aware of the details for the charges, and thus provides the user additional knowledge for the subscription to the CSP. This may, in turn, improve the overall relationships between user and service provider in a network environment.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing a cloud service provider (CSP), the method comprising:
detecting, by a service instance monitoring agent, usage of an infrastructure direct tracing (IDT) component, wherein the CSP comprises the IDT component;
based on the usage, identifying a service instance associated with the usage of the IDT component;
identifying a hardware resource corresponding to the IDT component;
updating a resource usage data structure that specifies the IDT component, the usage, and the hardware resource; and
providing a resource usage report to a client associated with the IDT component.

2. The method of claim 1, further comprising:
sending, by the service instance monitoring agent, an indirect tracing information request to an infrastructure indirect tracing (IIT) component;
obtaining, based on the indirect tracing information request, tracing information corresponding to second usage of the IIT component by the service instance; and
updating the resource usage data structure based on the tracing information.

3. The method of claim 2, wherein the IIT component is a storage device, and wherein the IDT component is a virtual machine.

4. The method of claim 2, wherein the indirect tracing information request is sent to the IIT component via the service instance.

5. The method of claim 1, wherein IDT component is one selected from a group consisting of: a server node and a virtual machine.

6. The method of claim 1, wherein the service instance is a database application instance, wherein the IIT component is a storage device, and wherein the database application instance stores data on the storage device.

7. The method of claim 1, wherein the service instance monitoring agent and the service instance execute on the IDT component.

8. A non-transitory computer readable medium comprising computer readable program code, which when executed by a computer processor enables the computer processor to perform a method for managing a client service provider (CSP), the method comprising:
detecting, by a service instance monitoring agent, usage of an infrastructure direct tracing (IDT) component, wherein the CSP comprises the IDT component;
based on the usage, identifying a service instance associated with the usage of the IDT component;
identifying a hardware resource corresponding to the IDT component;
updating a resource usage data structure that specifies the IDT component, the usage, and the hardware resource; and
providing a resource usage report to a client associated with the IDT component.

9. The non-transitory computer readable medium of claim 8, the method further comprising:
sending, by the service instance monitoring agent, an indirect tracing information request to an infrastructure indirect tracing (IIT) component;
obtaining, based on the indirect tracing information request, tracing information corresponding to second usage of the IIT component by the service instance; and
updating the resource usage data structure based on the tracing information.

10. The non-transitory computer readable medium of claim 9, wherein the IIT component is a storage device, and wherein the IDT component is a virtual machine.

11. The non-transitory computer readable medium of claim 9, wherein the indirect tracing information request is sent to the IIT component via the service instance.

12. The non-transitory computer readable medium of claim 8, wherein IDT component is one selected from a group consisting of: a server node and a virtual machine.

13. The non-transitory computer readable medium of claim 8, wherein the service instance is a database application instance, wherein the IIT component is a storage device, and wherein the database application instance stores data on the storage device.

14. The non-transitory computer readable medium of claim 8, wherein the service instance monitoring agent and the service instance execute on the IDT component.

15. A system comprising:
a processor; and
memory comprising instructions, which when executed by the processor, perform a method comprising:
detecting, by a service instance monitoring agent, usage of an infrastructure direct tracing (IDT) component, wherein a cloud service provider (CSP) comprises the IDT component;
based on the usage, identifying a service instance associated with the usage of the IDT component;
identifying a hardware resource corresponding to the IDT component;
updating a resource usage data structure that specifies the IDT component, the usage, and the hardware resource; and
providing a resource usage report to a client associated with the IDT component.

16. The system of claim 15, the method further comprising:
sending, by the service instance monitoring agent, an indirect tracing information request to an infrastructure indirect tracing (IIT) component;
obtaining, based on the indirect tracing information request, tracing information corresponding to second usage of the IIT component by the service instance; and
updating the resource usage data structure based on the tracing information.

17. The system of claim 16, wherein the IIT component is a storage device, and wherein the IDT component is a virtual machine.

18. The system of claim 16, wherein the indirect tracing information request is sent to the IIT component via the service instance.

19. The system of claim 15, wherein IDT component is one selected from a group consisting of: a server node and a virtual machine.

20. The system of claim 15, wherein the service instance is a database application instance, wherein the IIT component is a storage device, and wherein the database application instance stores data on the storage device.
